(19) United States
(12) Patent Application Publication
(10) Pub. No.: US 2021/0147182 A1
(43) Pub. Date: May 20, 2021

(54) NON-INTRUSIVE DATA ANALYTICS SYSTEM FOR ADAPTIVE INTELLIGENT CONDITION MONITORING OF LIFTS

(71) Applicant: Electrical and Mechanical Services Department, The Government of Hong Kong Special Administrative Re, Kowloon Bay (HK)

(72) Inventors: Ka Kei Cheung, Kowloon (HK); Xuran Ivan Li, Kowloon (HK); Chi Ho Eric Yip, Kowloon (HK); Lik Kee Lau, Kowloon (HK); Yuk Wa Ng, Kowloon (HK)

(73) Assignee: Electrical and Mechanical Services Department, The Government of Hong Kong Special Administrative Re

(21) Appl. No.: 17/098,562

(22) Filed: Nov. 16, 2020

(30) Foreign Application Priority Data
Nov. 19, 2019 (HK) 19132415.1

(51) Int. Cl. B66B 5/00; B66B 5/06; G06N 3/04; G06N 20/00

(52) U.S. Cl. CPC B66B 5/0031; G06N 20/00; G06N 3/04; B66B 5/06

(57) ABSTRACT

A lift operation safety analysis system with a controller arranged to: receive operation data of a lift; and process the operation data using an artificial intelligence based processing model to determine presence or otherwise of potential fault condition of the lift. The operation data processing system may be further operably connected with a database for storing data at the database and/or retrieving data from the database.

### TECHNICAL FIELD

The invention generally relates to lift operation safety analysis system and related method. More particularly, although not exclusively, the invention relates to a non-intrusive lift operation safety analysis system and related method.

### BACKGROUND

Lifts (also called elevators) are commonly used in buildings, vessels, or other structures to move people or goods between floors or levels. A lift is a relatively complex equipment. It includes various interconnected systems with movable mechanical parts and cooperating electrical parts, many of which are hidden from view of a user during normal operation of the lift.

Lifts of different ages, brands, models, etc., may have different constructions and properties. For example, older lifts generally do not have built-in condition monitoring systems; more modern lifts may have built-in condition monitoring systems, but these systems are not readily accessible and their performances do not improve over time.

Operation safety of lifts has always been a primary concern for building owners, lift maintenance contractors, lift manufacturers, lift users, and regulatory bodies. Currently, in the industry, preventive maintenance is the predominant way to maintain a lift. Licensed or registered lift mechanics would regularly visit a lift installation site to maintain and service the lift, to ensure that the lift is in safe and proper operation condition.

Provided that the maintenance is performed regularly (enough), the occurrence of lift operation failure and related accidents can be reduced. Problematically, however, an optimal maintenance frequency is often difficult to determine, as it may depend on various factors such as the age of the lift, the type of lift, the usage of the lift, the environment in which the lift is installed, the height or number of floors that the lift is arranged to service, etc. If the maintenance is not performed frequently enough, the risks associated with lift operation failure and related accidents may be realized. On the other hand, if maintenance is performed too frequently, resources (e.g., labor, cost, etc.) will be wasted.

### SUMMARY

In a first aspect, there is provided a non-intrusive data analysis system for adaptive intelligent condition monitoring of a lift. The non-intrusive data analysis system includes non-intrusive current sensors configured to acquire real-time electric current signals of traction motor, brake coil, and safety circuit of the lift; non-intrusive speed sensor configured to acquire real-time speed signals of a lift car of the lift; and a microcontroller. The microcontroller is configured to receive the electric current signals from the non-intrusive current sensors, receive the speed signals from the non-intrusive speed sensors, convert the received electric current signals and the received speed signals into signal data, and transmit the signal data to a server system that is configured to store the signal data and analyze the signal data based on deep learning to adaptively monitor operation condition of the lift. Optionally, the server system may provide warning or an alert about impending abnormal lift operation conditions, e.g., to a maintenance agency responsible for maintenance of the lift for necessary servicing with a view to preventing unexpected breakdown of the lift.

In some embodiments, the signals acquired by the non-intrusive current and speed sensors are continuous time-series data which forms the basis for on-line monitoring (continuously monitoring as the lift operates). This enables adaptively determination of whether a lift is operating properly or whether the lift deviates from the optimal or normal operation condition. The arrangement requires little or no intervention to the existing hardware and software of lift installations. The use of artificial intelligence based deep learning models to learn and analyze the operational peculiarities of the lift may enable early detection of abnormality.

In one embodiment of the first aspect, the current sensors comprise clamp-type current sensors.

In one embodiment of the first aspect, the microcontroller includes an internal storage unit. Optionally, the microcontroller is further configured to: read the electric current signals and the speed signals through a series of sampling and quantization processes, store the current and speed data in the internal storage unit, manage memory space of the internal storage unit based on “first-in-first-out” principle, and transfer, in real time, the current and speed data to the server system.

In one embodiment of the first aspect, the microcontroller is installed with a data transmitter that uses a dual modem to connect to two different types of mobile communication networks. The data transmitter may be arranged to transfer the acquired data to the server system using one of the network that has a higher signal strength or better performance.

In one embodiment of the first aspect, the non-intrusive data analysis system further includes the server system. The server system comprises: a data storage server configured to store the acquired signal data, and a data analysis server configured to analyze the signals using a trained deep learning model to adaptively monitor the operation conditions of the lift. The data analysis server is installed with a software with an algorithm that keeps scanning the acquired current and speed signals and then analyze the data using the trained deep learning model to adaptively monitor the operation conditions of the lift.

In one embodiment of the first aspect, the data analysis server is configured to perform feature extraction, classifier building, and fault identification, visualization of the condition monitoring results. The trained deep learning model is arranged to perform, at least, the following operations: inputting acquired data within the specified window length; performing data preprocessing; using the trained deep learning based network to analyze the processed data; monitoring whether the lift is operating normally; upon determining that the lift is operating normally, sliding the window by one step, and then reverting the process to analyze another set of processed data;

upon determining that the lift is operating abnormally, identifying the potential fault labels and giving warnings.

In one embodiment of the first aspect, the classifier building has two options, the first option is to perform feature extraction and then classification to give fault labels, and the second option is to perform deep learning based on the classifier to give fault labels. The two options may be employed simultaneously to identify different potential fault labels.

In one embodiment of the first aspect, the first option extracts the important features involved in the original acquired data, and then feeds the extracted features as inputs to a classifier to build the mapping relationship with the outputs which indicate the operational states, with the incoming data stream from various sensors, the trained classifier detects whether the operational states of lift are normal and gives labels of potential faults when abnormal.

In one embodiment of the first aspect, the second option uses the deep learning based classifier to learn the relationship between the acquired data and the outputs based on the desired performance index to give potential fault labels.

In a second aspect, there is provided a method for adaptive intelligent condition monitoring of a lift. The method comprises non-intrusively acquiring real-time electric current signals of the traction motor, brake coil and safety circuit of the lift and non-intrusively acquiring real-time speed signals of lift car; transmitting the electric current and speed signal data to a remote server for analyzing the data based on deep learning to adaptively monitor the operation conditions of the lift; and providing warnings or alerts upon determine possible abnormal lift operation condition, e.g., to maintenance agency of the lift, to enable necessary servicing of the lift to prevent unexpected breakdown of the lift.

In a third aspect, there is provided a lift operation safety analysis system, comprising a controller arranged to: receive operation data of the lift; and process the operation data using an artificial intelligence based processing model to determine presence or otherwise of potential fault condition of the lift. In one embodiment the controller is arranged to receive and process operation data of the lift as the lift operates so as to provide real time analysis of operation safety of the lift.

The system may also include a database operably connected with the controller. The database is arranged to store data to be retrieved by the controller and/or to store data received from the controller.

The controller may be arranged remotely from the lift, e.g. on a remote computing device or system in wireless communication with the lift, or locally at the lift, e.g., as part of the lift controller, or both (partly remotely and partly locally).

In one embodiment of the third aspect, the controller is further arranged to process the operation data using the artificial intelligence based processing model to identify, from a plurality of predetermined fault conditions, one or more potential fault condition present in the lift.

In one embodiment of the third aspect, the operation data of the lift comprises one or more (e.g., all) of: data associated with electric current in a traction device of the lift; data associated with electric current in a brake coil of the lift; data associated with electric current in a safety link circuit of the lift; data associated with electric current in a door control circuit of the lift; and data associated with motion (e.g., displacement, velocity, acceleration) of a lift car of the lift.

In one embodiment of the third aspect, the lift operation safety analysis system further includes one or more sensors connected with the controller and arranged to obtain the operation data of the lift. The sensor(s) may be non-intrusive sensor(s). For example, the sensor(s) may include: a current sensor for detecting electric current in a traction device of the lift; a current sensor for detecting electric current in a brake coil of the lift; a current sensor for detecting electric current in a safety link circuit of the lift; a current sensor for detecting electric current in a door control circuit of the lift; and/or a motion (e.g., displacement, velocity, acceleration) sensor for detecting with motion (e.g., displacement, velocity, acceleration) of a lift car of the lift. The motion sensor may include a laser rangefinder, optical/laser reflective tape tachometer assembly, etc.

In one embodiment of the third aspect, the artificial intelligence based processing model comprises an expert system based processing model, a trained machine learning based processing model, or both. The artificial intelligence based processing model may use only one model or use multiple models.

In one embodiment of the third aspect, the trained machine learning based processing model comprises a trained deep learning based processing model. The trained deep learning based processing model may include a trained recurrent neural network, e.g., a multivariate Long Short Term Memory with Fully Convolutional Network (MLSTM-FCN) model.

In one embodiment of the third aspect, the controller is further arranged to: pre-process the operation data prior to the processing using the artificial intelligence based processing model. The controller may be arranged to pre-process the operation data by dividing the operation data into substantially homogenous data segments each corresponding to a predetermined lift operation cycle. The predetermined lift operation cycle may comprise or consist essentially of a brake release event, a lift start event, a lift travel event, a lift stop event, a brake close event, a door open event, and a door close event, optionally in any sequence. It may be possible that an operation cycle include missing data such that one or more of these events are absent.

In one embodiment of the third aspect, the controller is further arranged to pre-process the operation data by identifying data segments with data loss to prevent processing of the identified data segments using the artificial intelligence based processing model. The identified data segments can be discarded, removed, or ignored in the subsequent processing.

In one embodiment of the third aspect, the expert system based processing model comprises predetermined rules; and the controller is arranged to determine statistical features of each data segments based on the predetermined rules and to determine presence or otherwise of potential fault condition based on the statistical features. In some examples, the lift operation safety analysis system is arranged to process operation data from different lifts or lift models, and each lift or lift model may have a respective (e.g., different) set of predetermined rules.

In one embodiment of the third aspect, the controller is further arranged to output a signal to provide or trigger a response upon determining presence of potential fault condition of the lift. In one example, the controller may be operably connected with an audible, tactile, and/or visual alarm, and the signal is to trigger the alarm (play a sound, vibration, and/or illuminate a light). In another example, the signal may include a lift operation suspension command arranged to be transmitted to the lift to suspend operation of the lift. In yet another example, the signal may be a message generation signal arranged to be transmitted to a server for sending an electronic notification to an electrical device (e.g., computer, phone, watch, tablet, etc.).

In one embodiment of the third aspect, the lift operation safety analysis system also includes a display operably connected with the controller and arranged to display information associated with the identified potential fault condition of the lift. The information associated with the identified potential fault condition of the lift includes an indication of the presence or absence of fault, or the specific type of fault identified, or both.

In a fourth aspect, there is provided a method of operating a lift operation safety analysis system, such as the one in the third aspect. The method includes receiving operation data of a lift; and processing the operation data using an artificial intelligence based processing model to determine presence or otherwise of potential fault condition of the lift. The receiving and processing of the operation data may be substantially real time during operation of the lift.

In one embodiment of the fourth aspect, the processing of the operation data using the artificial intelligence based processing model is further arranged to identify, from a plurality of predetermined fault conditions, one or more potential fault condition present in the lift.

In one embodiment of the fourth aspect, the operation data of the lift comprises one or more (e.g., all) of: data associated with electric current in a traction device of the lift; data associated with electric current in a brake coil of the lift; data associated with electric current in a safety link circuit of the lift;

data associated with electric current in a door control circuit of the lift; and data associated with motion (e.g., displacement, velocity, acceleration) of a lift car of the lift.

In one embodiment of the fourth aspect, the method further includes detecting the operation data of the lift using one or more sensor(s). The sensor(s) may be non-intrusive sensor(s). For example, the sensor(s) may include: a current sensor for detecting electric current in a traction device of the lift; a current sensor for detecting electric current in a brake coil of the lift; a current sensor for detecting electric current in a safety link circuit of the lift; a current sensor for detecting electric current in a door control circuit of the lift; and/or a motion (e.g., displacement, velocity, acceleration) sensor for detecting with motion (e.g., displacement, velocity, acceleration) of a lift car of the lift. The motion sensor may include a laser rangefinder, optical/laser reflective tape tachometer assembly, etc.

In one embodiment of the fourth aspect, the artificial intelligence based processing model comprises an expert system based processing model, a trained machine learning based processing model, or both. The processing of the operation data using the artificial intelligence based processing model may include processing the operation data using only one model, or it may include processing the operation data using multiple models.

In one embodiment of the fourth aspect, the trained machine learning based processing model comprises a trained deep learning based processing model. The trained deep learning based processing model may include a trained recurrent neural network, e.g., a multivariate Long Short Term Memory with Fully Convolutional Network (MLSTM-FCN) model.

In one embodiment of the fourth aspect, the method further includes, prior to processing the operation data using the artificial intelligence based processing model, pre-processing the operation data. The pre-processing may include dividing the operation data into substantially homogenous data segments each corresponding to a predetermined lift operation cycle. The predetermined lift operation cycle may comprise or consist essentially of a brake release event, a lift start event, a lift travel event, a lift stop event, a brake close event, a door open event, and a door close event, optionally in any sequence. It may be possible that an operation cycle include missing data such that one or more of these events are absent. The pre-processing may further include identifying data segments with data loss to prevent processing of the identified data segments using the artificial intelligence based processing model. The identified data segments can be discarded, removed, or ignored in the subsequent processing.

In one embodiment of the fourth aspect, the expert system based processing model comprises predetermined rules; and the processing of the operation data include determining statistical features of each data segments based on the predetermined rules and determining presence of potential fault condition based on the statistical features. In some examples, each lift or lift model may have a respective (e.g., different) set of predetermined rules.

In one embodiment of the fourth aspect, the method also includes outputting a signal to provide or trigger a response upon determining presence of potential fault condition of the lift. In one example, the signal is to trigger the alarm (play a sound, vibration, and/or illuminate a light). In another example, the signal may include a lift operation suspension command arranged to be transmitted to the lift to suspend operation of the lift. In yet another example, the signal may be a message generation signal arranged to be transmitted to a server for sending an electronic notification to an electrical device (e.g., computer, phone, watch, tablet, etc.).

In one embodiment of the fourth aspect, the method also includes displaying information associated with the identified potential fault condition of the lift. The information associated with the identified potential fault condition of the lift includes an indication of the presence or absence of fault, or the specific type of fault identified, or both.

In a fifth aspect, there is provided a lift operation safety analysis system, comprising a controller arranged to: receive operation data of the lift; selecting, from a plurality of artificial intelligence based processing models, based on a characteristics of the lift, an artificial intelligence based processing model for processing the operation data; and process the operation data using the selected artificial intelligence based processing model to determine presence or otherwise of potential fault condition of the lift.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF THE DRAWINGS

Embodiments of the invention will now be described, by way of example, with reference to the accompanying drawings in which:

FIG. 1 illustrates a system for adaptive intelligent condition monitoring of a lift in one embodiment of the invention;

FIG. 2 is a schematic view of an operation of adaptive intelligent condition monitoring of lifts in one embodiment of the invention;

FIG. 3 is a schematic view of lift fault prediction operation in one embodiment of the invention;

FIG. 4 is a flowchart illustrating a deep learning based data analysis method in one embodiment of the invention;

FIG. 5 is a schematic diagram of an operation environment including a lift and associated lift operation data collection and processing systems in one embodiment of the invention;

FIG. 6A is a block diagram of a controller in the lift operation data processing system of FIG. 5 in one embodiment of the invention;

FIG. 6B is a block diagram of a controller in the lift operation data processing system of FIG. 5 in another embodiment of the invention;

FIG. 6C is a block diagram of a controller in the lift operation data processing system of FIG. 5 in yet another embodiment of the invention;

FIG. 7 is a block diagram of the lift operation data collection system in FIG. 5 in one embodiment of the invention;

FIG. 8 is block diagram of an information handling system that can be used as a lift operation data processing system in one embodiment of the invention;

FIG. 9 is block diagram of a lift operation data processing system in one embodiment of the invention;

FIG. 10 is a schematic diagram illustrating processing of lift operation data using an expert system;

FIG. 11 is a schematic diagram illustrating processing of lift operation data using a machine learning based method;

FIG. 12 is a graph showing an exemplary lift operation data obtained using the lift operation data collection system;

FIG. 13 is a graph showing an exemplary lift operation data obtained using the lift operation data collection system;

FIG. 14 is a flow chart showing a method for determining operation safety of a lift using an expert system based processing model in one embodiment of the invention;

FIG. 15 is a flow chart showing a method for creating or modifying a machine learning based processing model that can be used for processing lift operation data in one embodiment of the invention;

FIG. 16 is a flow chart showing a method for creating or modifying a machine learning based processing model that can be used for processing lift operation data in one embodiment of the invention;

FIG. 17 is a flow chart showing a method for determining operation safety of a lift using a trained machine learning based processing model in one embodiment of the invention;

FIG. 18 is a schematic diagram showing a method for determining operation safety of a lift using a multivariate Long Short Term Memory with Fully Convolutional Network (MLSTM-FCN) model in one embodiment of the invention;

FIG. 19 is a flow chart showing a method for determining operation safety of a lift using a trained machine learning based processing model and an expert system based processing model in one embodiment of the invention;

FIG. 20 is a schematic diagram of an operation environment including multiple lifts, multiple associated lift operation data collection systems, and a lift operation data processing system in one embodiment of the invention;

FIG. 21 is a schematic diagram of an operation environment including a lift and associated lift operation data collection and processing systems in one embodiment of the invention; and

FIG. 22 is a schematic diagram that illustrates a system for adaptive intelligent condition monitoring of a lift in one embodiment of the invention.

### DETAILED DESCRIPTION

In the following, unless context requires otherwise, the expression “lift” is used generally to refer to a lift installation including not only the lift car but also various mechanical and electrical parts operably connected with the lift car.

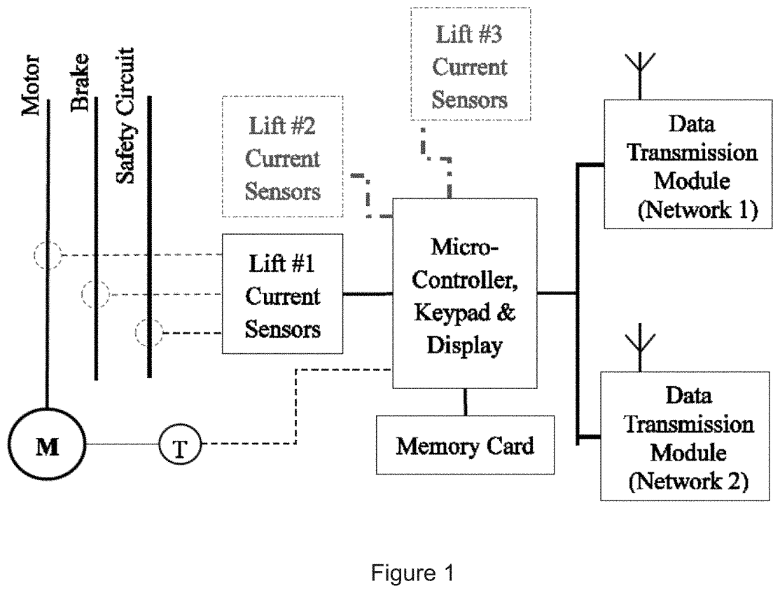

FIG. 1 shows a data analysis system for a lift. The data analysis system includes: non-intrusive current sensors configured to acquire real-time electric current signals of the traction motor, the brake coil, and the safety circuit of a lift; non-intrusive speed sensors configured to acquire real-time speed signals of a lift car of the lift; a microcontroller configured to receive or obtain the electric current signals from the non-intrusive current sensors and the speed signals from the non-intrusive speed sensors, convert the electric current signals and speed signals into signal data, and transmit the signal data to a server system. The server system may include a data storage server configured to store the acquired signal data and a data analysis server configured to analyze the signals based on deep learning to adaptively monitor the operation conditions of the lift.

In this embodiment, the non-intrusive current sensors are clamp-type current sensors. These sensors are used for monitoring the operation conditions of the traction motor, brake coil, and the safety circuit of the lift. Thus, the electric current signals in respect of the operation conditions of the traction motor, functioning of the brake coil, and tripping of the lift operation through activation of safety devices on the safety circuit can be acquired and recorded. Further, the non-intrusive speed sensors acquire speed-related signals of the lift car. The clamp-type current sensors and the non-intrusive speed sensors enable the electric current signals and the speed signals to be acquired simultaneously in real time.

The microcontroller is arranged to receive or obtain the electric current signals from the non-intrusive current sensors and the speed signals from the non-intrusive sensors. The microcontroller receives or obtains the electric current and speed signals through a series of sampling and quantization processes, converts the signals into signal data, and stores the signal data in an internal storage unit of the microcontroller. In one embodiment, the storage unit includes an SD card. The microcontroller is arranged to make use of the “first-in-first-out” principle to manage the memory space of the storage unit as appropriate. The microcontroller is arranged to transfer the signal data to the servers in real time.

Referring to FIG. 1, the microcontroller is installed with a data transmission module (DTM) arranged to transfer signal data to the servers. In this embodiment, the DTM uses a dual modem using two Subscriber Identity Module (SIM) cards. In this embodiment, the DTM uses the dual modem and is able to connect to two cellular communication networks (e.g., 3G, 4G, 5G, or next generation communication networks). When the signal strength of one of the mobile communication network is determined to be weak, the microcontroller is arranged to switch to the other mobile communication network to transmit signal data. By using multiple mobile communication networks, the possibility of data transmission failure caused by the microcontroller being located in a “blind-spot” can be greatly reduced. The use of cellular communication networks enables low cost and effective communications between the microcontrollers and the servers. In some embodiments, multiple DTMs can be used for data transmission.

In this embodiment, the servers include a data storage server used for storing signal data, and a data analysis server used for analyzing the signal data. An operator workstation, e.g., computer, can be set up to enable operators (e.g. local workstation) to analyze, search, view, and manage the real-time data and historical data stored in the data storage server. It is possible for the maintenance agency of the lift to monitor and analyze the information, with a view to enhancing the lift reliability and safety through early fault detection. In other embodiments, only one or more than two servers can be used for data storage and analysis.

A custom-made software runs in the data analysis server to analyze the operating data of lifts acquired from various sites. The software includes an algorithm arranged to process the data received, detect abnormal lift operation conditions, and predict potential faults. In one embodiment, a classification algorithm using the correlations between real-time signal data received and the ideal signal data (preset in the software or learnt by the software) is used to detect abnormal lift operation conditions.

The classification algorithm may operate as follows. First, the ideal signal data correlate itself to generate the ideal correlation features via training. The result of the correlation features is shown in a first graph. Then, the signal data acquired correlates with the ideal signal data to generate new features. The result of the correlation features is shown in a second graph. Next, the algorithm evaluates the feature(s) identified in the first graph (ideal operation) and the second graph (actual operation). If the difference in the feature(s) between the two graphs is greater than a preset threshold value, the algorithm will generate warning signals to indicate the abnormal operation.

Further, deep learning technologies can be used to build artificial intelligence models to enable learning and differentiate different types of operational characteristics and abnormalities of lifts with different configurations. When a sufficient mass of data is gathered from normal operations and abnormal operations, the data can be used to train AI models to self-learn the characteristics of normal operation and abnormal operation (i.e. when the electric current of the lift motor abnormally drops or rises). The AI models can be trained and retrained over time to improve the detection accuracy. In general, the detection accuracy increases with the number of types of faults. recorded. When a large number of the above-mentioned devices are deployed, they will form a large-scale Internet of Things (IoT) network that generates massive data continuously for analysis.

In one embodiment, recording various operation conditions during testing and commissioning of lift installations and during scheduled maintenance/examination creates various reference profiles. The algorithm running in the servers computes, analyzes and monitors the difference between the real-time operation conditions and the reference profiles, and provides warning signals when abnormality is detected.

In one embodiment, non-intrusive current sensors are used to acquire the electric current signals of major components and critical circuits, and non-intrusive speed sensors are used to acquire speed signals of lift cars. Using the data transmission module (e.g., a dual modem) to transmit data to the remote servers, the stability of data transmission can be improved. After receiving the signal data, the data storage server stores the signal data and then the data analysis server analyze the signal databased on deep learning, including pre-process the signals, perform feature extraction, fault identification and classifier building, so as to forecast the possible abnormal operation conditions for the lifts to inform the maintenance agency. The above embodiment could be used to monitor and warn in advance abnormalities for different types (e.g., brands) of lifts using different proprietary software programs, without intervening the existing hardware and software of the lift installations.

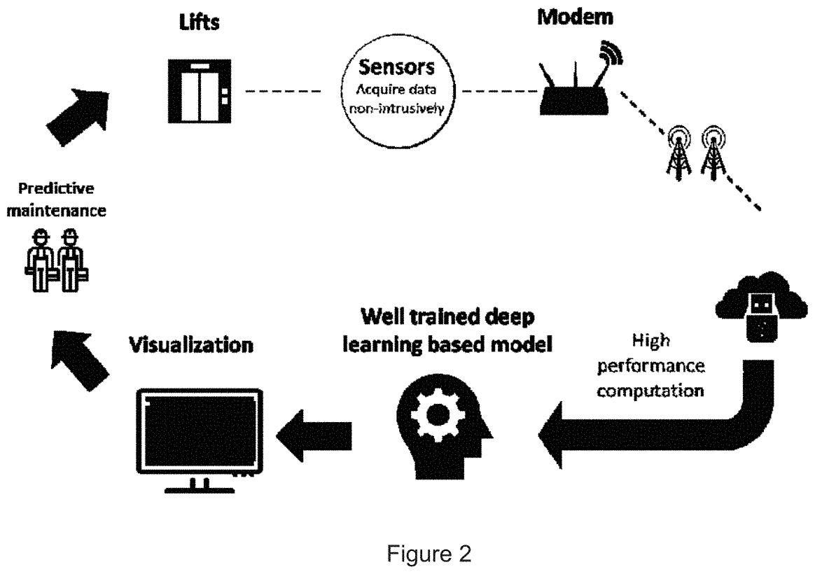

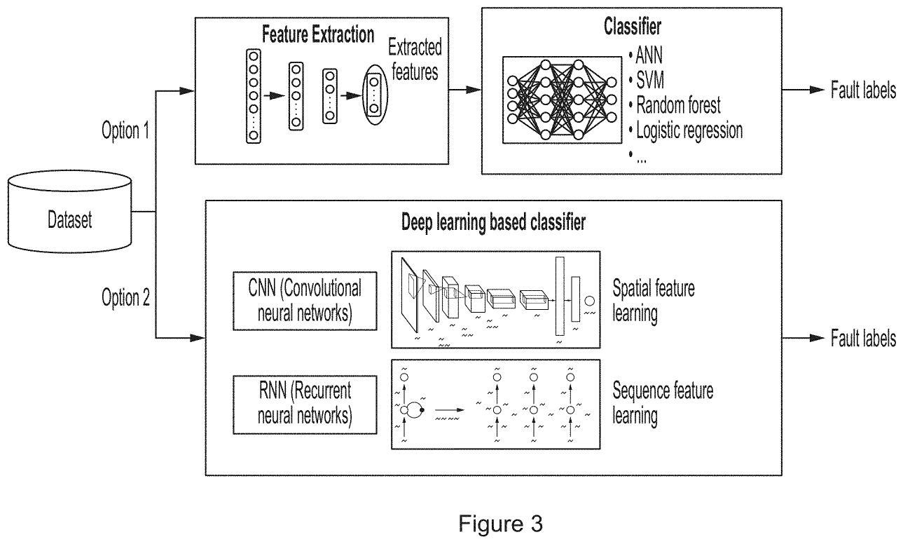

FIG. 2 shows a method for adaptive intelligent condition monitoring of lifts in one embodiment using a non-intrusive data analysis system, such as but not limited to the one of FIG. 1. As shown in FIG. 2, after receiving the current and speed signals of lifts, a remote server stores the signals and performs high performance computation to analyze the data. Specifically, the server is configured to process the data using a trained, deep learning based model and to enable visualization of the condition monitoring results, so as to predict potential faults using adaptive classifiers. One embodiment of the adaptive classifiers is shown in FIG. 3.

In one embodiment, monitoring of the electric current signals of the traction motor, the brake coil, and the safety circuit and the speed signals of the lift cars is performed using non-intrusive sensors. As such, there is limited or no intervention to the existing hardware and software of the lift installations. In one embodiment, only a few cost-effective sensors are needed to acquire the needed features to monitor the lifts.

Some embodiments of the invention utilize adaptive classifiers to obtain a high learning capability to detect the lift faults. An embodiment of classifier-based fault detection, with two options, is shown in FIG. 3.

The first option is to perform feature extraction and then classification to give potential fault labels. Specifically, the important features are extracted from the acquired data, and then the extracted features are fed as inputs to the classifier to build the mapping relationships with the outputs which indicate the operation conditions. With the incoming data stream from various sensors, the trained classifiers are capable of detecting whether the current/future operation conditions of lifts are normal, and giving labels of potential faults when abnormal.

The second option is to leverage a deep learning framework to directly learn the complex relationship between the inputs (various sensing signals) and outputs. Without any extra efforts on feature extraction, this model can effectively predict the current/future operation conditions of the lifts. In one embodiment, Convolutional Neural Network (CNN) learning models are trained, the input data are through a series of convolution layers, pooling layers and full connection layers to classify and give fault labels based on spatial feature learning. In another embodiment, the network nodes (in a tree-like hierarchy) of Recurrent Neural Network (RNN) recurse the input data according to their connection orders to classify and provide potential fault labels based on sequence feature learning.

In one embodiment, the two options are employed simultaneously to identify different potential fault labels. According to the potential fault labels, the abnormalities of the lifts could be informed to the maintenance agency.

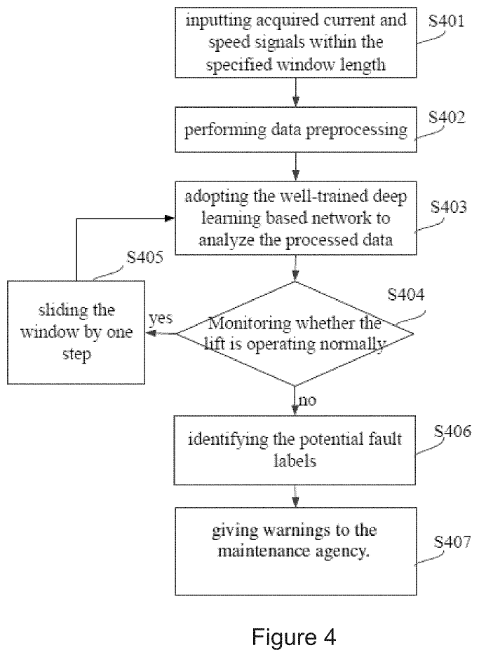

FIG. 4 shows a deep learning based data analysis method in one embodiment. This embodiment is arranged to extract informative signatures of the lift installations and reduce the dimensionality. It should be noted that any deep-learning-based models capable of achieving the purpose can be used in the method of FIG. 4. The method starts with step S401, inputting acquired current and speed signals within the specified window length. Then, in step S402, performing data preprocessing, and in step S403, using the trained deep-learning-based network to analyze the processed time-series data. In step S404, the method includes monitoring whether the lift is operating normally. If yes, the method proceeds to S405. It no, the method proceeds to S406. In step S405, the window is slid by one step, and the method returns to step S404. In step S406, potential fault labels are identified. Finally, in step S407, warning is provided to the lift maintenance agency upon identifying or detecting potential fault labels.

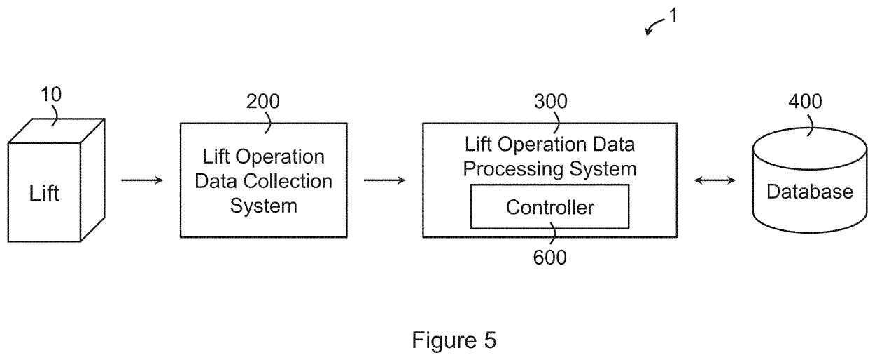

FIG. 5 shows an operation environment 1 in one embodiment of the invention. The environment 1 includes a lift 10, a lift operation data collection system 200, a lift operation data processing system 300, and a database 400. The lift operation data collection system 200 is operably connected with the lift 10 via a communication link to obtain operation data of the lift 10 during operation of the lift 10. The lift operation data collection system 200 includes sensors arranged to detect operation data of the lift 10. The communication link may include a wired connection link (e.g., cable), a wireless connection link, or both. In this embodiment the sensors are non-intrusive sensors arranged to detect operation data of the lift 10 in a non-intrusive manner. The non-intrusive sensors can be removably coupled with the lift 10 to obtain operation data of the lift 10 as needed, i.e., they need not be pre-installed (e.g., hard-wired) in or at the lift 10. The lift operation data processing system 300 is operably connected with the lift operation data collection system 200 via a communication link, which may include a wired connection link, a wireless connection link, or both. The operation data processing system 300 has a controller 600 and is arranged to receive and process lift operation data from the lift operation data collection system 200, on-line in real time during operation of the lift 10, or off-line, to determine presence (or absence) of potential fault condition of the lift 10, and optionally, to identify one or more potential fault condition present in the lift 10. In this embodiment, the controller 600 is arranged to process the operation data using one or more artificial intelligence based processing models as well as artificial intelligence based processing, as will be further described below. The artificial intelligence based processing model(s) may include one or more expert system based processing models, one or more trained machine learning based processing models, or any of their combination. The operation data processing system 300 is further operably connected with a database 400 via a communication link, which may include a wired connection link, a wireless connection link, or both, for storing data (e.g., processing result) at the database 400 or retrieving data (e.g., data processing model) from the database 400.

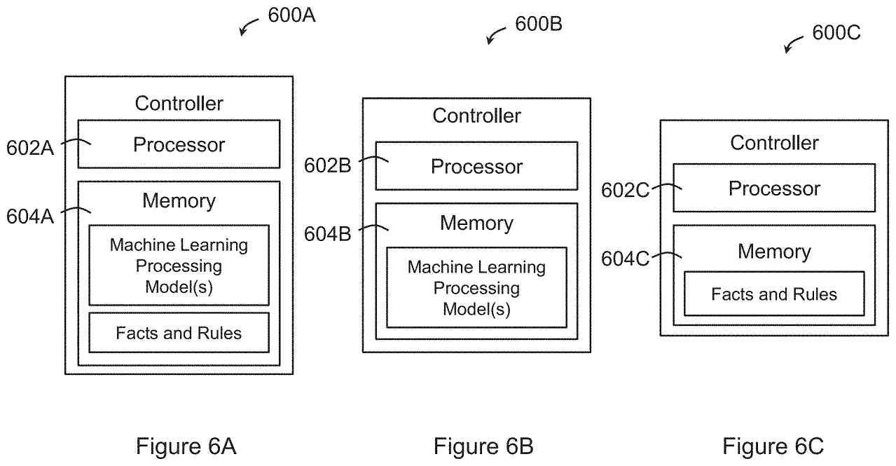

FIGS. 6A to 6C show some exemplary controllers 600A, 600B, 600C in the lift operation data processing system 300 of FIG. 5. The controllers 600A, 600B, 600C in FIGS. 6A-6C each includes a respective processor 602A, 602B, 602C and a respective memory 604A, 604B, 604C. Each of the processor 602A, 602B, 602C may include, respectively, one or more of: CPU, MCU, controllers, logic circuits, Raspberry Pi chip, digital signal processor (DSP), application-specific integrated circuit (ASIC), Field-Programmable Gate Array (FPGA), or any other digital or analog circuitry configured to interpret and/or to execute program instructions and/or to process information and/or data. Each of the memory 604A, 604B, 604C may include, respectively, one or more volatile memory unit (such as RAM, DRAM, SRAM), one or more non-volatile memory unit (such as ROM, PROM, EPROM, EEPROM, FRAM, MRAM, FLASH, SSD, NAND, and NVDIMM), or any of their combinations.

The controller 600A in FIG. 6A is arranged to process lift operation data using expert system based processing model(s) and trained machine learning based processing model(s), which are stored in the memory 604A. Each expert system based processing model(s) may be adapted for processing operation data of a respective type or model of lift; each trained machine learning based processing model(s) may be adapted for processing operation data of a respective type or model of lift. The controller 600A is configured to use a trained machine learning based processing model to process the lift operation data, to determine whether any potential fault conditions is present in the lift, and in some embodiments, also identify the specific fault conditions from predetermined fault conditions. The controller 600A is also configured to use an expert system based processing model, with predetermined facts and rules, to process the lift operation data, e.g., inference, to determine whether any potential fault conditions is present in the lift, and in some embodiments, also identify the specific fault conditions from predetermined fault conditions. In one embodiment, the controller 600A processes each set of operation data using one or more expert system based processing models and one or more trained machine learning based processing models. The use of multiple models on the same dataset may improve accuracy of the determination at the expense of computational resources and speed.

The controller 600A may be arranged to initialize, construct, train, and/or update the machine learning based processing models based on supervised learning or unsupervised learning. As an example, in supervised learning, the controller 600A can be presented with example input-output pairs, e.g., formed by example inputs and their actual outputs, to learn a general rule or model that maps the inputs to the outputs based on the provided example input-output pairs. The machine learning based processing model(s) are preferably recurrent model(s). Exemplary model(s) include, e.g., recurrent neural network, long-short term memory model (e.g., MLSTM-FCN model), Markov process, reinforcement learning, gated recurrent unit model, deep neural network, convolutional neural network, support vector machines, principle component analysis, logistic regression, decision trees/forest, ensemble method (combining model), regression (Bayesian/polynomial/regression), stochastic gradient descent, linear discriminant analysis, nearest neighbor classification or regression, naive Bayes, etc.

Each machine learning based processing model can be trained to perform spectral signal processing or classification task for a specific type, class, brand, or model of lift. For example, the machine learning based processing model can be trained to determine, based on lift operation data, whether the lift is normal or abnormal, and optionally, to identify the specific abnormality (e.g., door motor malfunction, grid voltage dip, brake not fully opened, etc.). The training of different machine learning processing models can be different. For example, the training examples/data used to train different machine learning based processing models may include different information and may have different dimensions.

In one embodiment, training examples are provided to the controller 600A and the controller 600A uses them to generate or train a model (e.g., a rule, a set of equations, and the like), i.e., a machine learning based processing model, that helps categorize an output based on new input data. The controller 600A may weigh different training examples differently to, for example, prioritize different conditions or outputs. In one example, the machine learning based processing model comprises an artificial neural network that includes an input layer multiple hidden layers or nodes, and an output layer, operably connected with one another. The number of inputs may vary based on the particular task. Accordingly, the input layer of different artificial neural networks may have a different number of nodes based on the particular task for the controller. The number of hidden layers varies and may depend on the particular task for the model. Each hidden layer may have a different number of nodes and may be connected to the adjacent layer in a different manner. For example, each node of the input layer may be connected to each node of the first hidden layer, and the connections may each be assigned a respective weight parameter. In one example, each node of the neural network may also be assigned a bias value. The nodes of the first hidden layer may not be connected to each node of the second hidden layer, and again, the connections are each assigned a respective weight parameter. Each node of the hidden layer may be associated with an activation function that defines how the hidden layer is to process the input received from the input layer or from a previous hidden layer (upstream). These activation functions may vary. Each hidden layer may perform a different function. For example, some hidden layers can be convolutional hidden layers for reducing the dimensionality of the inputs, while other hidden layers can perform more statistical functions such as averaging, max pooling, etc. The last hidden layer is connected to the output layer, which usually has the same number of nodes as possible outputs. During training, the artificial neural network receives the inputs for a training example and generates an output using the bias for each node, and the connections between each node and the corresponding weights. The artificial neural network then compares the generated output with the actual output of the training example. Based on the generated output and the actual output of the training example, the neural network changes the weights associated with each node connection. In some embodiments, the neural network also changes the weights associated with each node during training. The training continues until, for example, a predetermined number of training examples being used, an accuracy threshold being reached during training and validation, a predetermined number of validation iterations being completed, etc. Hyper-parameters can be adjusted to further optimize the model.

Each expert system based processing model can be applied to perform spectral signal processing or classification task for a specific type, class, brand, or model of lift. For example, the expert system based processing model can, based on the knowledge base of facts and rules, make interference from the data to obtain statistical measure or features of the data, which can then be used to determine whether the lift is normal or abnormal, and optionally, to identify the specific abnormality (e.g., excessive door opening time, excessing door closing time, abnormal motor and brake restart, brake improperly opens when door opens, etc.).

The expert system based processing model(s) and the trained machine learning based processing model(s) stored in the memory 604A can be updated as needed. For example, new facts and rules of an expert system based processing model can be provided to the controller to update or overwrite the existing facts and rules associated with that model. The trained machine learning based processing model can be updated or re-trained locally at the controller 600A, or remotely at an external device or system then loaded to the controller 600A.

The controller 600B in FIG. 6B is similar to the controller 600A in FIG. 6A, except that the controller 600B is only arranged to process the lift operation data using machine learning based processing model(s). Description related to machine learning based processing model(s) in FIG. 6A is applicable to FIG. 6B. The controller 600B can use one or more machine learning based processing model(s) to process the same dataset.

The controller 600C in FIG. 6C is similar to the controller 600A in FIG. 6A, except that the controller 600C is only arranged to process the lift operation data using expert system based processing model(s). Description related to expert system based processing model(s) in FIG. 6A is applicable to FIG. 6C. The controller 600C can use one or more expert system based processing model(s) to process the same dataset.

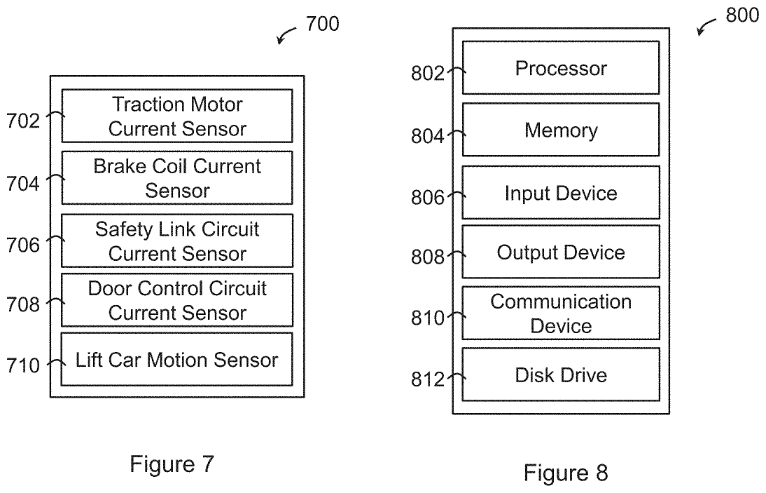

FIG. 7 shows a lift operation data collection system 700 in one embodiment of the invention. The system 700 may be used as the lift operation data collection system 200 in FIG. 5. The system 700 includes a traction device (e.g., traction motor) current sensor 702, a brake coil current sensor 704, a safety link circuit current sensor 706, a door control circuit current sensor (e.g., on a PCB) 708, and a lift car motion sensor 710. These sensors are preferably non-intrusive sensors and preferably can be retrofitted to existing lift installations to collect operation data for those installations. The traction device current sensor 702 is arranged to detect the electric current flowing in or through the traction device (e.g., motor) during operation of the lift. The brake coil current sensor 704 is arranged to detect the electric current flowing in or through the brake coil circuit during operation of the lift. The safety link circuit current sensor 706 is arranged to detect the electric current flowing in or through the safety link circuit during operation of the lift. The door control circuit current sensor 708 is arranged to detect the electric current flowing in or through the door control circuit (that controls opening and closing of the lift car door) during operation of the lift. The lift car motion sensor 710 is arranged to detect motion, in this embodiment velocity, of the lift during operation of the lift. The measurements simultaneously collected by these sensors 702-710 during operation of the lift provide temporal operation data of the lift, which is used to subsequent processing to determine potential fault conditions. In some embodiments, only one of the sensors 702-710 is used during operation of the lift, or only some of the sensors 702-710 are used simultaneously during operation of the lift, to provide temporal operation data of the lift, which is then processed for potential fault determination and/or identification.

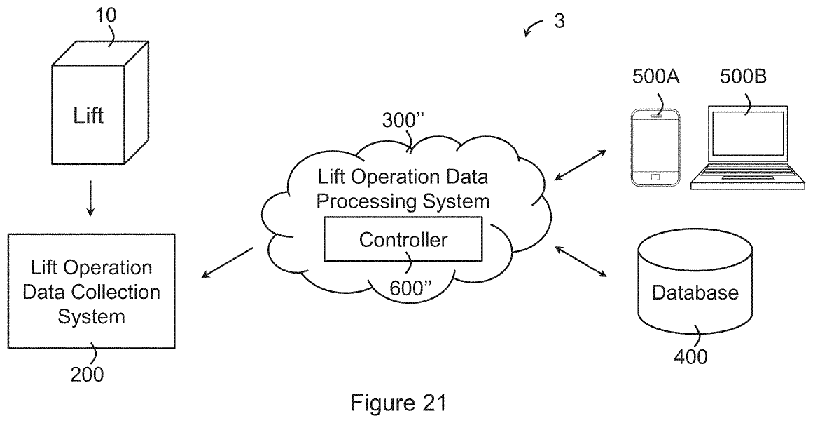

FIG. 8 shows an exemplary information handling system 800 that can be used as a server, a database (such as those in FIGS. 5, 20, and 21), a lift operation data processing system (such as those in FIGS. 5, 9, 20, and 21), or another type of information processing system or user devices (such as that in FIG. 21) in one embodiment of the invention. The information handling system 800 generally comprises suitable components necessary to receive, store, and execute appropriate computer instructions, commands, or codes. The main components of the information handling system 800 are a processor 802 and a memory (storage) 804. The processor 802 may include one or more of: CPU, MCU, controllers, logic circuits, Raspberry Pi chip, digital signal processor (DSP), application-specific integrated circuit (ASIC), Field-Programmable Gate Array (FPGA), or any other digital or analog circuitry configured to interpret and/or to execute program instructions and/or to process signals and/or information and/or data. The memory 804 may include one or more volatile memory (such as RAM, DRAM, SRAM), one or more non-volatile memory (such as ROM, PROM, EPROM, EEPROM, FRAM, MRAM, FLASH, SSD, NAND, and NVDIMM), or any of their combinations. Appropriate computer instructions, commands, codes, models, rules, facts, information and/or data may be stored in the memory 804. Optionally, the information handling system 800 further includes one or more input devices 806. Examples of such input device 806 include one or more of: keyboard, mouse, stylus, image scanner (e.g., identifier (barcode, QR code, etc.) scanner), microphone, tactile/touch input device (e.g., touch sensitive screen), image/video input device (e.g., camera), biometric data input device (e.g., fingerprint detector, facial detector, etc.), etc. Optionally, the information handling system 800 further includes one or more output devices 808. Examples of such output device 808 include one or more of: display (e.g., monitor, screen, projector, etc.), speaker, disk drive, headphone, earphone, printer, additive manufacturing machine (e.g., 3D printer), etc. The display may include a LCD display, a LED/OLED display, or any other suitable display that may or may not be touch sensitive. The information handling system 800 may further include one or more disk drives 812 which may encompass one or more of: solid state drive, hard disk drive, optical drive, flash drive, magnetic tape drive, etc. A suitable operating system may be installed in the information handling system 800, e.g., on the disk drive 812 or in the memory 804. The memory 804 and the disk drive 812 may be operated by the processor 802. Optionally, the information handling system 800 also includes a communication device 810 for establishing one or more communication links (not shown) with one or more other computing devices such as servers, personal computers, terminals, tablets, phones, watches, IoT devices, or other wireless or handheld computing devices. The communication device 810 may include one or more of: a modem, a Network Interface Card (NIC), an integrated network interface, a NFC transceiver, a ZigBee transceiver, a Wi-Fi transceiver, a Bluetooth® transceiver, a radio frequency transceiver, an optical port, an infrared port, a USB connection, or other wired or wireless communication interfaces. Transceiver may be implemented by one or more devices (integrated transmitter(s) and receiver(s), separate transmitter(s) and receiver(s), etc.). The communication link(s) may be wired or wireless for communicating commands, instructions, information and/or data. In one example, the processor 802, the memory 804, and optionally the input device(s) 806, the output device(s) 808, the communication device 810 and the disk drives 812, are connected with each other through a bus, a Peripheral Component Interconnect (PCI) such as PCI Express, a Universal Serial Bus (USB), an optical bus, or other like bus structure. In one embodiment, some of these components may be connected through a network such as the Internet or a cloud computing network. A person skilled in the art would appreciate that the information handling system 800 shown in FIG. 8 is merely exemplary and that the information handling system 800 can in other embodiments have different configurations (e.g., additional components, fewer components, etc.).

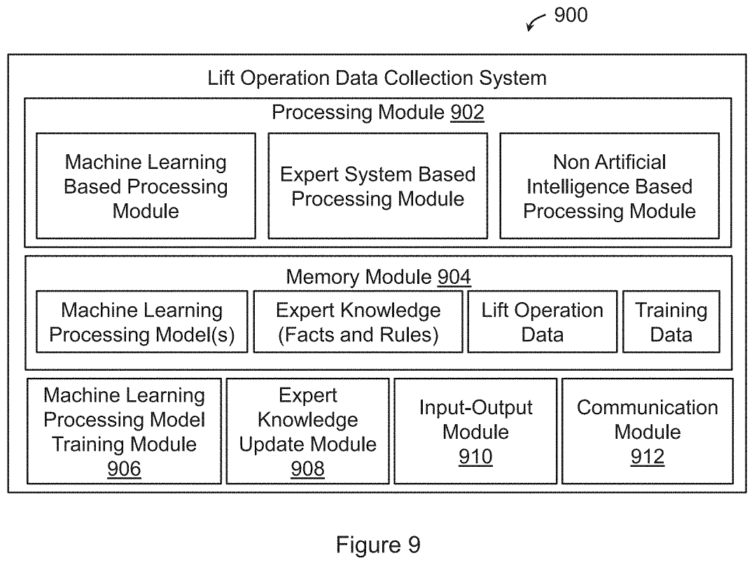

FIG. 9 shows the functional blocks of a lift operation data processing system 900 in one embodiment of the invention. The lift operation data processing system can be implemented in a single apparatus or across multiple apparatuses in a distributed manner. The lift operation data processing system 900 may be but need not be the lift operation data processing system 300 in FIG. 5. It should be appreciated that the blocks illustrated in FIG. 9 are functional blocks which do not delimit structures and can be implemented by any combination of hardware components and/or software components. It should also be appreciated that one or more of the functional blocks can be removed and one or more additional functional blocks can be added to provide different lift operation data processing system embodiments.

As shown in FIG. 9, the lift operation data processing system 900 has a processing module 902, a memory module 904, a machine learning processing model training module 906, an expert knowledge update module 908, an input-output module 910, and a communication module 912.

The processing module 902 includes a machine learning based processing module that is arranged to process (and optionally pre-process) operation data of the lift using one or more machine learning based processing method(s). The processing module 902 also includes an expert system based processing module that is arranged to process operation data of the lift using one or more expert system based processing models each with respective sets of knowledge (rules and facts). The machine learning based processing module and the expert system based processing module are responsible for performing artificial intelligence based processing of the lift operation data. The processing module 902 also includes a non artificial intelligence based processing module that is arranged to process lift operation data. The non artificial intelligence based processing module may be arranged to performing one or more of the following signal processing on the lift operation data: filtering, segmenting, thresholding, averaging, normalizing, smoothing, padding, transforming, translating, rotating, scaling, etc. Preferably, the operation data is first processed at the non artificial intelligence based processing module before being processed by the artificial intelligence based processing module(s).

The memory module 904 stores one or more machine learning processing model(s). The stored machine learning processing model can be used by the machine learning based processing module to process data. In one embodiment, multiple machine learning processing model(s) are stored, and the machine learning based processing module is arranged to select the suitable model for processing the data. The selection may be based on a user selection, e.g., received via the input-output module 910, or based on detection of characteristics of the data (e.g., the type, brand, model, etc., of the lift of which the data belongs).

The memory module 904 stores also one or more set of expert knowledge each containing respective facts and rules. The stored expert knowledge can be used by the expert system based processing module to process data. In one embodiment, multiple sets of expert knowledge are stored, and the expert system based processing module is arranged to select the suitable set of expert knowledge for processing the data. The selection may be based on a user selection, e.g., received via the input-output module 910, or based on detection of characteristics of the data (e.g., the type, brand, model, etc., of the lift of which the data belongs).

The memory module 904 also stores lift operation data, which includes data received from a lift operation data collection system, such as the one in FIG. 5 or 7, as well as interim or final processing result determined by the processing module 902. The memory module 904 also stores training data used for training the machine learning processing model(s). Different training dataset may be stored for use with different machine learning processing model(s).

The data, model, knowledge, etc., stored in the memory module 904 can be updated, replaced, deleted, and/or transmitted to an external device, such as a server, via the input-output module, for storage. New data, model, knowledge, etc. can be added to the memory module 904.

The machine learning processing model training module 906 is arranged to select or use the appropriate training data, optionally with a suitable weighting and hyper-parameters, for training of the machine learning processing model(s) in the memory module 904. The expert knowledge update module 908 is arranged to manage the expert knowledge, update the rules and/or facts, in the memory module 904.

The input-output module 910 provides a user interface that enables the user to interact with the system 900. The system 900 can receive user input, command, or any other information or data provided by the user through the input-output module 910. These user input, command, information, data can be used by the system 900 in the processing of the data, training of the model, updating of the knowledge, etc. The system can also present or otherwise provide the processing result or indication to the user via the input-output module 910.

The communication module 912 is used to enable communication of the system 900 with an external device (external to the system, e.g., computer, server, phone, etc.). Lift operation data for processing, user input/command (e.g., to add, edit, remove data, etc.), and the like can be received at the system 900 via the communication module 912. Processing output, result, response, and the like can be provided to the external device for storage, for triggering a response or action, etc. via the communication module 912.

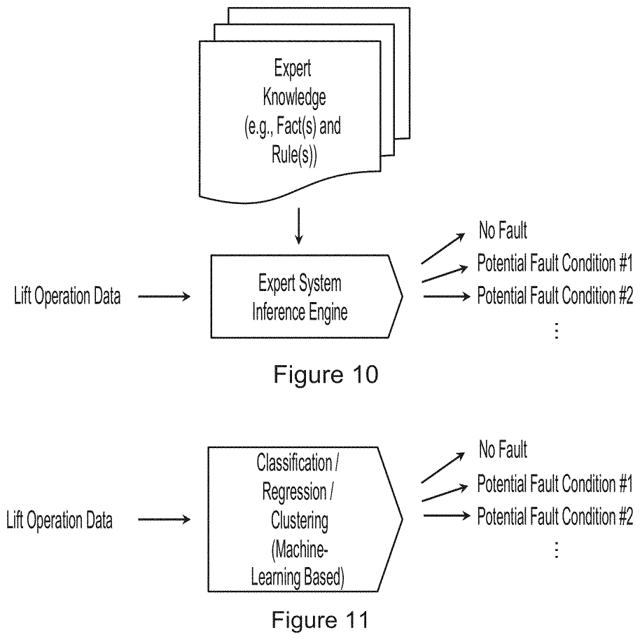

FIG. 10 illustrates processing of the lift operation data using expert system based processing, which can be implemented in a lift operation data processing system such as but not limited to those described herein. The lift operation data is pre-processed before being applied to the expert system inference engine (e.g., part of an expert system based processing module). The pre-processing includes partitioning the raw temporal lift operation data (e.g., electric current signals and/or motion signals) into homogenous multivariate segments each representing an operation cycle. The partitioning may be based on artificial intelligence based method or non artificial intelligence based method. In one embodiment an operation cycle includes the following sequence of events: brake releases, lift starts up, lift travels, lift stops, brake closes, door opens, and door closes. In other embodiments, the operation cycle may be defined differently. In one example, the pre-processing also includes identifying data segments with incomplete data to remove or otherwise discard them from subsequent processing. The identifying may be based on artificial intelligence based method or non artificial intelligence based method. Other pre-processing techniques may be applied to the data prior to processing with the expert system. After the operation data has been pre-processed, the data segments are then applied to the expert system inference engine. The expert system inference engine analyzes the data based on expert knowledge including rules and facts, to infer, from the data (per operation cycle), whether the lift has any potential fault conditions. In one example, the rules and facts may relate to: (i) door operation (e.g., number of door open/close before lift startup; door open/close operation time interval (door speed); brake current shall be zero (except relevelling); door current range; door open for too long; door motor current is still on for holding the door close when lift is travelling); (ii) traction device (e.g., motor) operation: (e.g., travelling time (whole range/depends on distance); acceleration time (depends on distance); deceleration time (depends on distance); starting current range (depends on load/up or down); steady current range (depends on load/up or down); deceleration current range (depends on load/up or down); time interval between motor startup and brake open); (iii) Brake Operation (Double Brake) (e.g., when one or both brake is close, traction motor must be off; both brake shall operate simultaneously (except self-check mode); both brake shall open before traction motor run; brake shall close after traction motor stop; when brake is open, door motor must be off (except relevelling); brake starting current; brake steady current; time interval between brake starting and brake steady current; (optional self-check mode done automatically daily) brake operate one at a time while lift is at stop); (iv) safety circuit operation (e.g., safety circuit shall be open only when any of safety switches, devices engage; current spikes at unknown times); etc. The expert system inference engine analyses the data segments to obtain feature statistics of one or more of the above measures, and compare the feature statistics based on the rules and facts, to determine whether the lift includes any potential fault condition(s) or which potential fault condition(s) is present. The features statistics may include calculation of mean, standard deviation, maximum, minimum, per operation cycle or per data set (of multiple operation cycles). The potential fault condition(s) may include door failure, brake failure, etc. (e.g., door open/close with odd cycles, excessive door open duration, excessive door closure duration, abnormal motor/brake restart during operation cycle, brake open when door opens, etc.). In one example, if the number of abnormalities or statistics measure exceeds a predetermined number per cycle, or exceeds a predetermined number per dataset, then the lift is identified as in a potential faulty state. As another example, if the number of abnormalities or statistics measure falls below a predetermined number per cycle, or falls below a predetermined number per dataset, then the lift is identified as in a potential faulty state. Multiple statistical measures may be taken into account, optionally given different weights, to determine the fault status. In some implementations, the process may identify more than one type of fault that the lift has.

FIG. 11 illustrates processing of the lift operation data using machine learning based processing, which can be implemented in a lift operation data processing system such as but not limited to those described herein. The lift operation data used in this process are also preferably pre-processed based on the pre-processing described with respect to FIG. 10. After the operation data has been pre-processed, the data segments are then applied to a trained machine learning based processing model, which uses classification, regression, clustering, or any of their combination, to determine whether the lift includes any potential fault condition(s) or which potential fault condition(s) is present. In one implementation a deep learning based model, e.g., a multivariate LSTM-FCN, is applied. In some implementations, the process may identify more than one type of fault that the lift has.

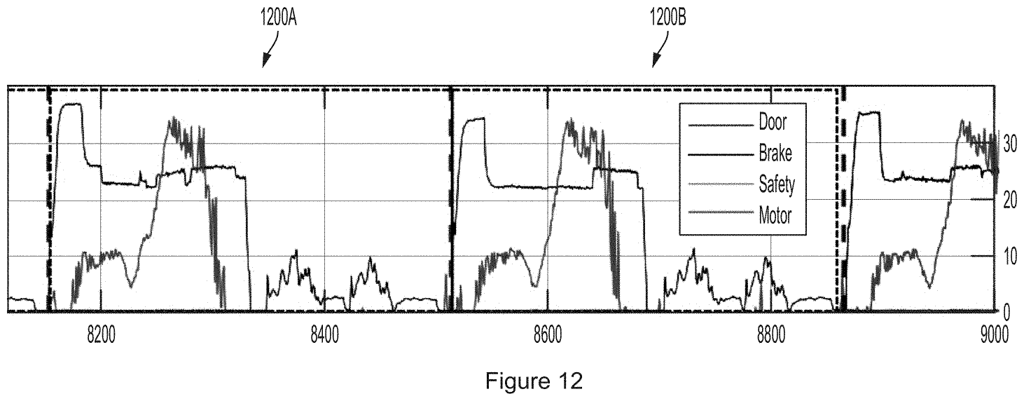

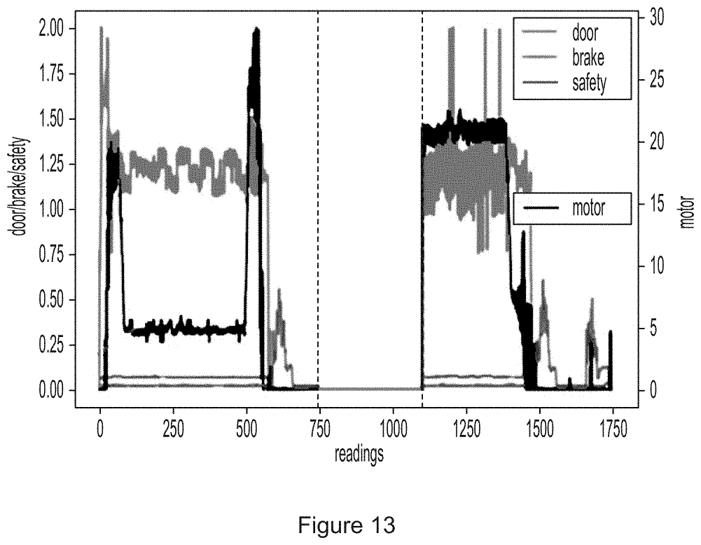

FIG. 12 shows a graph of operation data including current measure of door of the lift, brake coil of the lift, safety link circuit of the lift, and traction device of the lift. The operation data shown includes multiple data segments 1200A, 1200B. FIG. 13 is a graph of operation data segment with data loss or otherwise incomplete data, which may be discarded or removed from further processing.

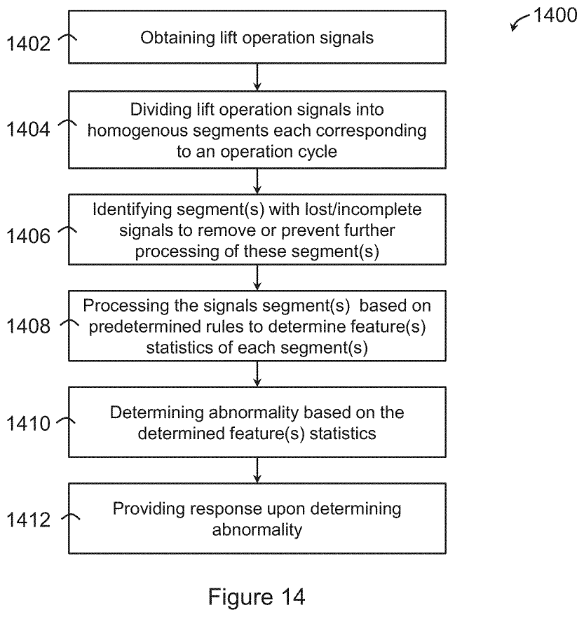

FIG. 14 is a computer-implemented method 1400 of determining operation safety of a lift using an expert system based processing model in one embodiment of the invention, which can be implemented using, among other things, a lift operation data processing system such as but not limited to those described herein. The method 1400 begins in step 1402, in which the lift operation signals/data are obtained. Then, in step 1404, the lift operation signals/data are divided into homogenous segments, e.g., homogenous multivariate segments, each corresponding to an operation cycle of the lift. The operation cycle is predefined, and it may include or comprise of a sequence of events described above with respect to FIG. 10. Once the segmentation is done, then in step 1406, the segments with incomplete data or data loss are identified and are removed or otherwise prevented from further processing. In step 1408, the remaining signal segments are processed using an expert system inference engine, with predetermined rules and facts, to determine features statistics of the data segments. The features statistics of each data segment may be analysed individually; or the features statistics of multiple data segment may be combined for analysis. Based on the obtained feature statistics, in step 1410, the expert system inference engine determines whether the lift has any potential abnormal condition and if so, which potential abnormal condition(s) it has. Upon determining any potential abnormality, in step 1412, a response is provided or triggered. The response may be the actuation of an alarm, the sending of an electronic message to a user device (e.g., mobile phone, computer) to alert the user to take action (before any potentially hazardous incident occurs).

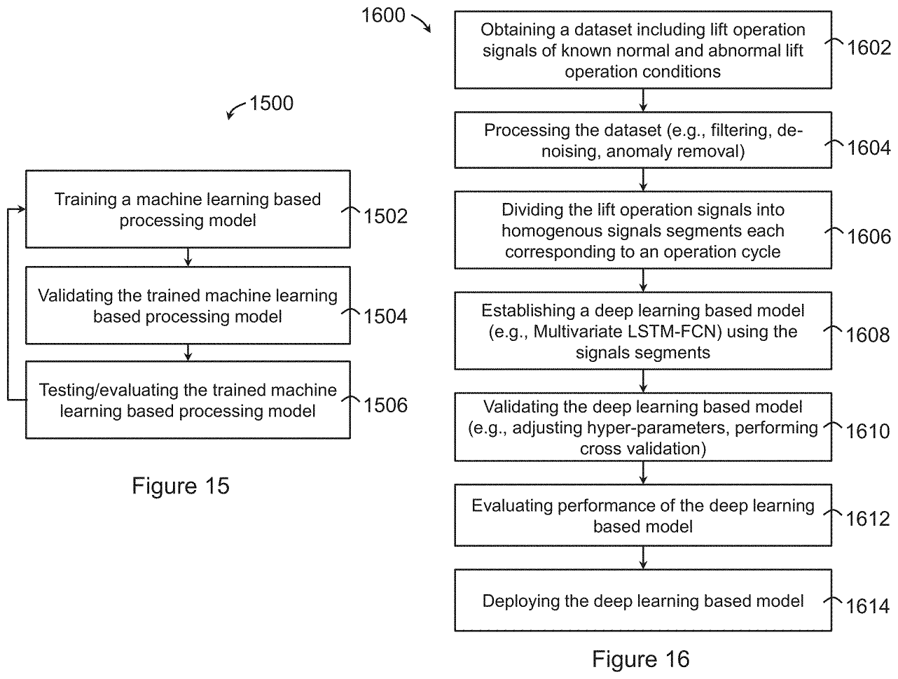

FIG. 15 shows a computer-implemented method 1500 for creating, training, or modifying machine learning based processing model that can be used for processing lift operation data in one embodiment of the invention. The method 1500 includes, in step 1502, training a machine learning based processing model using a training dataset (which includes normal operation data and fault data of lift); in step 1504, validating the trained machine learning model using a validation dataset (which includes normal operation data and fault data of lift); and in step 1056, testing or evaluating the trained learning based processing model using test dataset. The training may be conducted offline. During validation hyper-parameters can be adjusted to optimize the model. In testing, performance characteristics such as accuracy, sensitivity, specificity, F-measure, and the like, can be obtained. Comparison with benchmark models may also be performed. The trained model can be updated, periodically or otherwise, to take into account new data, scenario, fault, etc., for improved classification performance.

FIG. 16 shows a computer-implemented method 1600 for creating or modifying a machine learning based processing model that can be used for processing lift operation data in one embodiment of the invention. The method 1600 can be seen as a specific example of the method 1500 of FIG. 15. The method 1600 begins in step 1602, in which a dataset including lift operation signals/data of known normal and abnormal (faulty) lift operation conditions are obtained. The lift operation signals/data of abnormal (faulty) lift operation conditions can be real or simulated. Then in step 1604, the method proceed s to process the dataset using signal processing techniques such as filtering, denoting, smoothing, anomaly removal, thresholding, etc. Afterwards, in step 1606, the lift operation signals are divided into homogeneous, preferably multivariate, data segments. These data segments are then used, in step 1608, to establish, create, or train a deep learning based processing model (e.g., a multivariate LSTM-FCN model), using supervised or unsupervised learning. In step 1610, the deep learning based model is then validated. The validation includes using adjusting hyper-parameters, performing cross validation, etc. Then in step 1612, the performance of the validated model is evaluated, or tested. If the test result is not satisfactory, the method can return to step 1608 or 1610, to re-do training and/or validation. Other datasets can alternatively or additionally be used to achieve this effect. If the test result is satisfactory, then the method 1600 continues to step 1614, in which the deep learning based model, trained, validated, and tested properly, is deployed.

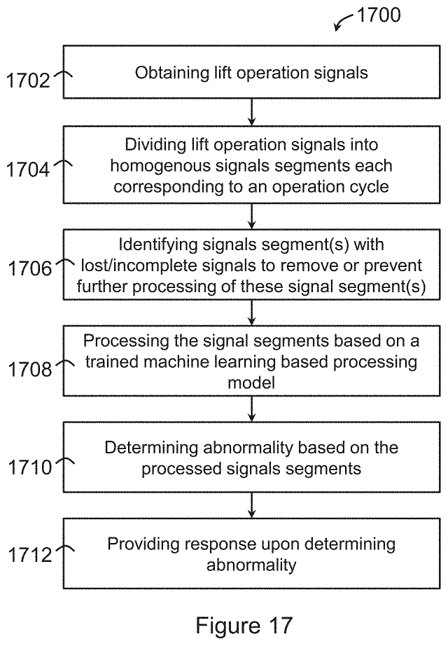

FIG. 17 shows a computer-implemented method 1700 for determining operation safety of a lift using a trained machine learning based processing model in one embodiment of the invention. The method 1700 begins in step 1702, in which lift operation data is obtained. Then in step 1704, the lift operation data/signals are divided into homogenous, preferably multivariate, segments each corresponding to a lift operation cycle as defined above. In step 1706, the segments with incomplete data or data loss are identified and not further processed. In step 1708, the data segments or signal segments are processed using the trained machine learning based processing model. The trained machine learning based processing model is trained to identify, based on the operation data of the lift, whether the lift has any potential fault and preferably the specific potential fault condition(s) that the lift has. This determination is made in step 1710, after which, if any abnormality is detected, a response is provided or triggered in step 1712. The response may be the actuation of an alarm, the sending of an electronic message to a user device (e.g., mobile phone, computer) to alert the user to take action (before any potentially hazardous incident occurs).

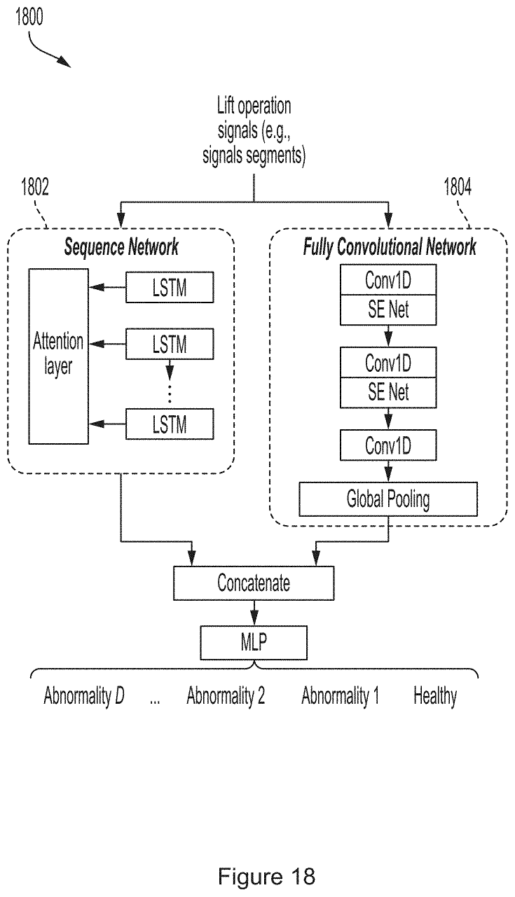

FIG. 18 is a specific implementation 1800 of the method 1700 of FIG. 17, in which a multivariate Long Short Term Memory with Fully Convolutional Network (MLSTM-FCN) model is used as the trained machine learning based processing model for processing the lift operation data segments. As shown in FIG. 18, the multivariate Long Short Term Memory with Fully Convolutional Network (MLSTM-FCN) model includes a sequence network 1802 and a fully convolutional network 1804 that acts in parallel to process the lift operation data to determine potential fault or abnormality condition of the lift.

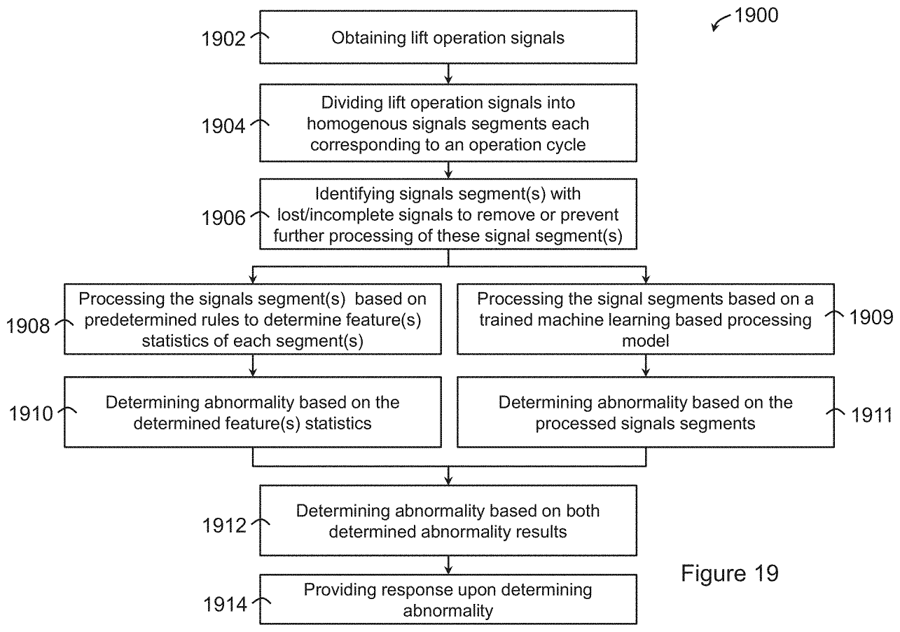

FIG. 19 shows a computer-implemented method for determining operation safety of a lift using a trained machine learning based processing model and an expert system based processing model in one embodiment of the invention. In method 1900, steps 1902 to 1906 generally correspond to steps 1702 to 1706 in FIG. 17 and steps 1402 to 1406 in FIG. 14 so are not further described here. Steps 1908 and 1910 generally correspond to steps 1408 and 1410 in FIG. 14 so are not further described here. Steps 1909 and 1911 generally correspond to steps 1708 and 1710 in FIG. 17 so are not further described here. In step 1912, the method 1900 determines abnormality of the lift based on the determined abnormality results obtained from the trained machine learning based processing model and the expert system based processing model. The same weighting or different weightings may be given to the result obtained from the trained machine learning based processing model and result obtained from the expert system based processing model. In one example, if one model indicates that there is a fault and the other model indicates that there is no fault, then the method 1900 may determine that there is nonetheless a fault, or may determine whether there is actually a fault based on the plausibility (e.g., weighting) of the results generated by the model. In one implementation, when one model determines that there is a fault, or that there is a specific type of fault, then the fault, or the specific type of fault, may be considered as present, regardless of the determination of the other model.

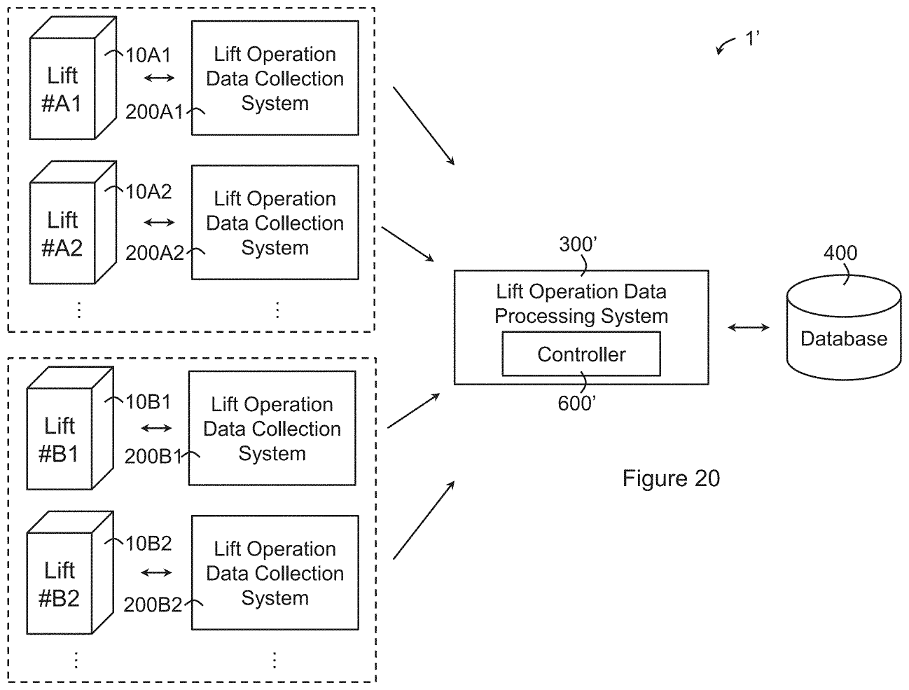

FIG. 20 shows an operation environment 1′ including multiple lifts 10A1, 10A2, 10B1, 10B2, multiple associated lift operation data collection systems 200A1, 200A2, 200B1, 200B2, a lift operation data processing system 300′, and a database 400′ in one embodiment of the invention. The environment 1′ is similar to the environment 1 in FIG. 5. The lifts 10A1, 10A2, 10B1, 10B2 are similar to the lift 10 in FIG. 5; the lift operation data collection systems 200A1, 200A2, 200B1, 200B2 are similar to the lift operation data collection system 200 in FIG. 5; the lift operation data processing system 300′ (and controller 600′) is similar to the lift operation data processing system 300 (and controller 600) in FIG. 5; the database 400′ is similar to the database 400 in FIG. 5. In this environment 1′, lifts 10A, 10A2 are of different types, brands, model, etc., than lifts 10B1, 10B2. The lift operation data processing system 300′ is arranged to receive and process data from different types, brands, model, etc., of lifts using respective artificial intelligence based processing model preferably specific to those lift types, brands, models, etc. Further, the lift operation data processing system 300′ can learn (e.g., be trained) over time from different lifts of the same types, brands, models, etc. As a result the accuracy and robustness of the lift operation data processing system 300′ can improve more quickly over time.

FIG. 21 shows an operation environment 3 which is modified based on the environment 1 of FIG. 5. The operation environment 3, same as environment 1, includes a lift 10, a lift operation data collection system 200, and a database 400. The operation environment 3 also includes a lift operation data processing system 300″ (with controller 600″) similar to the lift operation data processing system 300 in FIG. 5. The lift operation data processing system 300″ can operate online, continuously as the lift(s) operate, to on-line monitor operation data of lift(s). However, the lift operation data processing system 300″ is implemented in a cloud computing device or network. The operation environment 3 also includes one or more user devices 500A, 500B in communication with the lift operation data processing system 300″ so that upon determining abnormality the lift operation data processing system 300″ can send a command or electronic message to those devices 500A, 500B.

In one implementation, the lift operation data processing system 300″ is arranged to process the lift operation data and transmit the data and/or the result to the user device 500A, 500B for display, storage, and/or further processing.

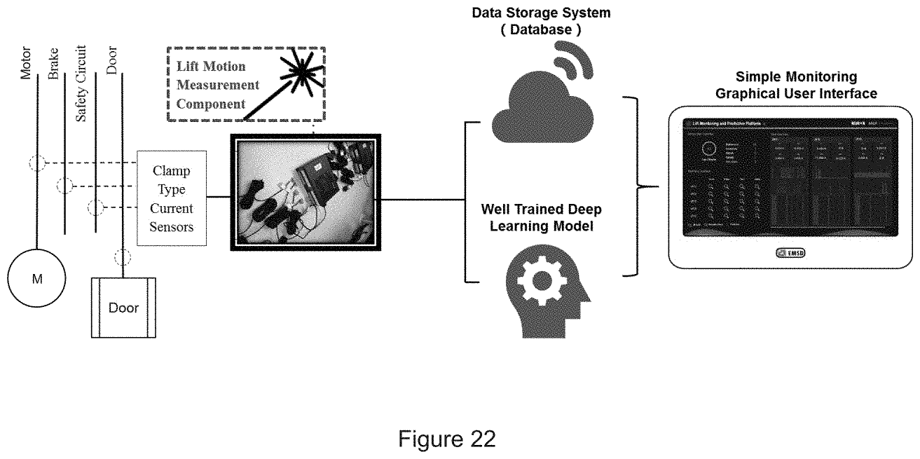

FIG. 22 shows an exemplary system for adaptive intelligent condition monitoring of a lift. The system includes clamp type current sensors (motor sensor, brake sensor, safety circuit sensor, door sensor) for detecting current associated with the traction motor of the lift, the brake coil of the lift, the safety link circuit of the lift, and the door control circuit of the lift, as well as motion measurement component or sensor for detecting motion of the lift. These sensors are connected to a controller, which is connected to a server system that is arranged to process the data and store the collected and/or processed data. The processing of the data is based on processing methods described above. An electrical device operably connected to the server system provides a graphical user interface for displaying processing result to the data and receiving user input. Embodiments of detailed operation of the system have been described above so will not be repeated here.

The above embodiments have provided, among other things, a lift operation safety analysis system and related method for determining potential fault condition in lifts. In some embodiments, the system is non-intrusive and can be retrospectively applied to existing monitor safety of existing lifts. In some embodiments, there is provided a data analysis system for adaptive intelligent condition monitoring of lift installations. The electric current signals of the traction motor, brake coil and safety circuit of a lift and optionally speed signals of the lift car are used to analyze the operation conditions of a lift. The data analysis system is particularly useful for monitoring machinery/plants with critical electromagnetic drives, safety circuits, emergency interlocks or brake coils of lifts, and detecting potential faults of lifts before any hazardous or otherwise unwanted fault event actually occurs. Through the lift operation safety analysis system, the operator or user of the system can determine presence or absence of hidden danger associated with the lift and determine when a lift needs to be serviced (and can do so in a timely manner to reduce or eliminate the chance of risk being realized).

Although not required, the embodiments described with reference to the Figures can be implemented as an application programming interface (API) or as a series of libraries for use by a developer or can be included within another software application, such as a terminal or computer operating system or a portable computing device operating system. Generally, as program modules include routines, programs, objects, components and data files assisting in the performance of particular functions, the skilled person will understand that the functionality of the software application may be distributed across a number of routines, objects and/or components to achieve the same functionality desired herein.

It will also be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computing system” and “computing device” are used, these terms are intended to include (but not limited to) any appropriate arrangement of computer or information processing hardware capable of implementing the function described.

It will be appreciated by persons skilled in the art that numerous variations and/or modifications may be made to the invention as shown in the specific embodiments to provide other embodiments of the invention. Different methods/systems herein can be selectively combined to form new methods/systems. The described embodiments of the invention should therefore be considered in all respects as illustrative, not restrictive.

For example, the lift data analysis system can be integrated as part of the lift, or it may be arranged on a server (e.g., on a cloud computing network). Any number of sensor(s) may be used to detect the operation data. In some cases, only one sensor is used to detect one type of operation data of the lift; in some other cases, multiple sensors are used to detect different types of operation data of the lift. In some embodiments, the sensor(s) for detection operation data of the lift can be intrusive sensor(s). The sensor(s), regardless of whether they are intrusive type or non-intrusive type, can include current sensor(s), voltage sensor(s), capacitance sensor(s), inductance sensor(s), motion sensor(s), or any combination thereof. The artificial intelligence based processing model, e.g., the expert system based processing model or the trained machine learning based processing model, can be modified. Various types of trained machine learning based processing model, in particular deep learning based processing model, suitable for processing temporal lift operation data can be used. The pre-processing of the data may be based on artificial intelligence based method or non artificial intelligence based method (or both).

1. A non-intrusive data analysis system for adaptive intelligent condition monitoring of a lift, the non-intrusive data analysis system comprising:
non-intrusive current sensors configured to acquire real-time electric current signals of traction motor, brake coil, and safety circuit of the lift;
non-intrusive speed sensor configured to acquire real-time speed signals of a lift car of the lift; and
a microcontroller configured to
receive the electric current signals from the non-intrusive current sensors,
receive the speed signals from the non-intrusive speed sensors,
convert the received electric current signals and the received speed signals into signal data, and
transmit the signal data to a server system that is configured to store the signal data and analyze the signal data based on deep learning to adaptively monitor operation condition of the lift.

2. The non-intrusive data analysis system of claim 1, wherein the current sensors comprise clamp-type current sensors.

3. The non-intrusive data analysis system of claim 1, wherein the microcontroller includes an internal storage unit and is further configured to
read the electric current signals and the speed signals through a series of sampling and quantization processes,
store the current and speed data in the internal storage unit,
manage memory space of the internal storage unit based on “first-in-first-out” principle, and
transfer, in real time, the current and speed data to the server system.

4. The non-intrusive data analysis system of claim 3,
wherein the microcontroller is installed with a data transmitter that uses a dual modem arranged to connect to two mobile communication networks; and
wherein the data transmitter is arranged to transfer the acquired data to the server system using the network with a higher signal strength.

5. The non-intrusive data analysis system of claim 1, further comprising the server system, and wherein the server system comprises:
a data storage server configured to store the acquired signal data, and a data analysis server configured to analyze the signals using a trained deep learning model to adaptively monitor the operation conditions of the lift;
wherein the data analysis server is installed with a software with an algorithm that continuously scan the acquired current and speed signals and then analyze the data using the trained deep learning model to adaptively monitor the operation conditions of the lift.

6. The non-intrusive data analysis system of claim 5, wherein the data analysis server is configured to perform feature extraction, classifier building, and fault identification, visualization of the condition monitoring results;
wherein the trained deep learning model is arranged to perform, at least, the following operations:
inputting acquired data within the specified window length;
performing data preprocessing;
using the trained deep learning based network to analyze the processed data;
monitoring whether the lift is operating normally;
upon determining that the lift is operating normally, sliding the window by one step, and then reverting the process to analyze another set of processed data;
upon determining that the lift is operating abnormally, identifying the potential fault labels and giving warnings.

7. A lift operation safety analysis system, comprising:
a controller arranged to:
receive operation data of a lift; and
process the operation data using an artificial intelligence based processing model to determine presence or otherwise of potential fault condition of the lift.

8. The lift operation safety analysis system of claim 7, wherein the controller is further arranged to process the operation data using the artificial intelligence based processing model to identify, from a plurality of predetermined fault conditions, one or more potential fault condition present in the lift.

9. The lift operation safety analysis system of claim 7, wherein the operation data of the lift comprises one or more of:
data associated with electric current in a traction device of the lift;
data associated with electric current in a brake coil of the lift;
data associated with electric current in a safety link circuit of the lift;
data associated with electric current in a door control circuit of the lift; and
data associated with motion of a lift car of the lift.

10. The lift operation safety analysis system of claim 7, wherein the artificial intelligence based processing model comprises one or both of:
an expert system based processing model; and
a trained machine learning based processing model.

11. The lift operation safety analysis system of claim 10, wherein the trained machine learning based processing model comprises a trained recurrent neural network.

12. The lift operation safety analysis system of claim 11, wherein the trained recurrent neural network comprises a multivariate Long Short Term Memory with Fully Convolutional Network (MLSTM-FCN) model.

13. The lift operation safety analysis system of claim 10, wherein the controller is further arranged to:
pre-process the operation data prior to the processing using the artificial intelligence based processing model.

14. The lift operation safety analysis system of claim 13, wherein the controller is arranged to pre-process the operation data by:
dividing the operation data into substantially homogenous data segments each corresponding to a predetermined lift operation cycle.

15. The lift operation safety analysis system of claim 14, wherein the predetermined lift operation cycle consists essentially of: a brake release event, a lift start event, a lift travel event, a lift stop event, a brake close event, a door open event, and a door close event.

16. The lift operation safety analysis system of claim 7, further comprising a database operably connected with the controller, the database being arranged to store data to be retrieved by the controller and/or to store data received from the controller.

17. The lift operation safety analysis system of claim 14,
wherein the expert system based processing model comprises predetermined rules; and
wherein the controller is arranged to determine statistical features of each data segments based on the predetermined rules and to determine presence of potential fault condition based on the statistical features.

18. The lift operation safety analysis system of claim 7, wherein the controller is further arranged to:
output a signal to trigger a response upon determining presence of potential fault condition of the lift.

19. The lift operation safety analysis system of claim 7, further comprising one or more of:
one or more non-intrusive sensors connected with the controller and arranged to obtain the operation data of the lift; and
a display operably connected with the controller and arranged to display information associated with the identified potential fault condition of the lift.

20. A lift operation safety analysis system, comprising:
a controller arranged to:
receive operation data of a lift;
select, from a plurality of artificial intelligence based processing models, based on a characteristics of the lift, an artificial intelligence based processing model for processing the operation data; and
process the operation data using the selected artificial intelligence based processing model to determine presence or otherwise of potential fault condition of the lift.
